(19) United States
(12) Patent Application Publication
(10) Pub. No.: US 2021/0304760 A1
(43) Pub. Date: Sep. 30, 2021

(54) System and Method for Structuring Chat History Using Machine-Learning-Based Natural Language Processing

(71) Applicant: Proto Research Inc., Toronto (CA)

(72) Inventor: Wen-Lih CHUANG, Toronto (CA)

(21) Appl. No.: 17/345,755

(22) Filed: Jun. 11, 2021

Related U.S. Application Data
(63) Continuation of application No. PCT/CA2019/051772, filed on Dec. 9, 2019.
(60) Provisional application No. 62/778,042, filed on Dec. 11, 2018.

(51) Int. Cl. G10L 15/22; G10L 15/06; G10L 15/16; H04L 12/58

(52) U.S. Cl. CPC G10L 15/22; G10L 15/063; G10L 2015/225; H04L 51/02; G10L 15/16

(57) ABSTRACT

There is provided a system and method of chat structuring. The method comprises obtaining data associated with one or more chats; labeling a set of seed conversations from the data; and executing a chat structuring algorithm as herein described.

### CROSS-REFERENCE TO RELATED APPLICATIONS

The present application is a continuation of international PCT Application No. PCT/CA2019/051772 filed on Dec. 9, 2019, which claims priority from U.S. Provisional Application No. 62/778,042 filed on Dec. 11, 2018 both incorporated herein by reference in their entireties.

### TECHNICAL FIELD

The following relates to systems and methods for structuring chat histories using machine-learning-based natural language processing.

### BACKGROUND

Many enterprises are found to be investing in customer service automation, particularly bots, normally referred to as “chatbots”. A chatbot is an intelligent or otherwise automated conversational agent that typically augments a human customer service agent but may also operate autonomously. These enterprises are moving towards using chatbots since adopting automated customer support, e.g., on a messaging app or widget have an operating cost and service advantage.

Intelligent conversational agents are therefore becoming increasingly popular, and most known chatbots fall into certain categories, namely: (i) keyword repliers, (ii) chit-chat, and (iii) button bots.

(i) In a keyword replier, candidate responses are selected if a user utterance contains certain words or terms. Examples of such keyword repliers includes AutoReply provided by Facebook Messenger, WeChat, and LINE@.

(ii) In chit-chat bots, open domain small talk or entertaining responses are provided, depending on a rough natural language understanding (NLU), and a minimum level of information access. An example of a chit-chat bot can be found in for example, Xiaolce.

(iii) In button bots, the bot does not require natural language processing (NLP) at all. Instead, dialog states and logic are presented as rich-context (i.e. UI elements) such as menus, buttons, quick replies, and carousels. This type of bot is typically used as a replacement for single-use apps like catalogs or for weather checking, etc.

It is desirable to use chatbots to automate business processes, extend service hours, and improve customer experiences. However, automated customer service in call centers face challenges that can be more complex than the above scenarios.

To begin with, enterprises that employ a chatbot typically do not know how to extract knowledge from chat histories. When it comes to adopting a chatbot to take over some customer service requests, the first mission is to enumerate the tasks that can be automated, e.g., asking for promotional activities, forgetting passwords, querying a delivery status, booking an event or appointment, etc. Call centers often hold a considerable number of transcriptions between customers and agents. However, without knowing how to utilize the content in these transcriptions, the content can even become a burden.

For example, the enterprise may rely on their agents' collaborative feedback to compile a standard list of frequently asked questions (FAQs). However, it is found that the result of human efforts in such cases can be of high precision but low recall. In other words, it has been found that people are adept at listing most common questions but tend to miss those that are not frequent enough to remember yet are fixed and simple enough to automate. This leaves much room for improvement in a customer service environment where a chatbot can be advantageous.

Moreover, NLP is important for these applications. Most call centers have a variety of channels to serve the end-users besides messaging apps, including customized software, messaging apps, web chats, and SMS systems where rich context is not necessarily available. Since all interactions are done via raw text, chatbots would not work at all without mature NLU and NLP techniques.

One challenge that is imposed is that various tasks can occur in various utterances. For example, while common chatbots only need to handle a few tasks, (button bots are limited to 3-5 tasks due to the limitation of UI elements), customer service agents are typically dealing with many more different kinds of questions every day (e.g., 100 or more). To automate the simple and repeated requests among them, a NLP engine would need to support a large number of vocabularies and intents.

Another challenge is related to domain-specific terms. In the business of a large enterprise, there are typically at least some special words and/or slang that cannot be recognized or processed by general NLP tools. This is much more significant for languages like Chinese that rely heavily on word segmentation as the first step.

It is an object of the following to address at least one of the above-noted challenges.

### SUMMARY

In one aspect, there is provided a method of chat structuring comprising: obtaining data associated with one or more chats; labeling a set of seed conversations from the data; and executing a chat structuring process.

In an implementation, the method further comprises developing specific natural language processing from the data during a bot execution process.

In an implementation, the method further comprises providing the data to an annotator to receive labels for a plurality of chat dialogues.

In an implementation, an output of the chat structuring is used to develop a conversation script for a chat bot to follow. The conversation script can be displayed in a bot diagram, used to apply dialogue state modeling for bot execution.

In an implementation, the method further comprises receiving bot responses and feeding the bot responses to an optimization process to provide natural feedback for refining the natural language processing for subsequent bot executions.

In an implementation, the method further comprises providing an option to have a bot execution process taken over by a customer service agent for generating a final response.

In an implementation, the chat structuring process comprises predicting how likely a response comes from an utterance. For each turn in a dialogue, a bidirectional long short term memory encoder can be applied to obtain sentence embedding. The method can also further include determining a likelihood of a response conditioning on an utterance.

In an implementation, a training objective is used to minimize a negative log-likelihood over an entire corpus. Dialogue turns with the likelihood of response conditioning on the utterance being larger than a threshold can be considered triggers. The method can further include randomly sampling a plurality of conversations; and applying a supervision process to annotate the sampled conversations.

In another aspect, there is provided a computer readable medium comprising computer executable instructions for performing the method.

In yet another aspect, there is provided a system for chat structuring comprising a processor and memory, the memory storing instructions for performing the method.

### BRIEF DESCRIPTION OF THE DRAWINGS

Embodiments will now be described with reference to the appended drawings wherein:

FIG. 1 is a schematic block diagram of a system utilizing a chatbot and a chatbot creation, editing, and execution system;

FIG. 2 is a flow diagram illustrating bot building, bot execution, bot optimization and human take over stages in a chatbot workflow utilizing machine-learning-based NLP;

FIG. 3 is a screen shot of an example of a chatbot messaging user interface;

FIG. 4 is a flow chart illustrating operations performed in processing a chat history;

FIG. 5 is a screen shot of an example of a bot creation user interface;

FIG. 6 is a screen shot of an example of a bot editor user interface;

FIG. 7 is a screen shot of an example of a user interface for integrating a chat bot with a human agent interface; and

FIG. 8 is a screen shot of an example of a chat bot trainer user interface.

### DETAILED DESCRIPTION

It has been found that academic researchers and industrial developers pay most attention to NLP or machine learning tools in order to understand raw text and/or manage dialog. It has also been recognized that those techniques are important in building a successful bot. However, for big enterprises and call centers that want to reduce labor costs and increase service throughput, knowing how many tasks can be automated is considered to be more important.

As a result, to find all repeated conversations from chat histories is a viable but often overlooked topic. The system described herein has been configured to implement a method to find the initiating turns (triggers) of each task. The system implements a semi-supervised algorithm requiring little human labeling and is scalable to large amounts of data.

Most end-to-end deep learning chatbots are made by seq2seq and its variants. Seq2seq can be considered as the conditional language model. However, the conditional language model is ineffective in conversation, where an utterance may have multiple possible choice responses due the changes of dialogue context. It is hard for maximum likelihood estimation (MLE) methods like supervised neural networks to learn the latent semantics, let alone to cluster utterances by their intents.

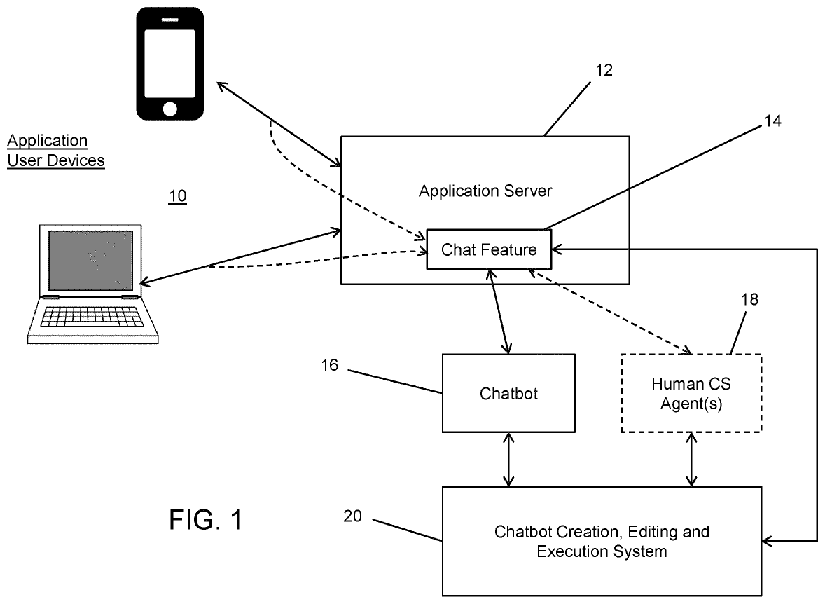

Turning now to the figures, FIG. 1 illustrates an exemplary environment in which one or more users (e.g., clients, customers, consumers, players, etc.) are engaging or interacting with or otherwise participating in execution of an application. The application can relate to anything that has or could have a customer/user/player service that enables the customer/user/player to interact and submit queries, referred to generally as a “customer service” or a CS component. Examples of such applications can include, without limitation: online gaming, banking, regulatory services, telecommunication services, e-commerce, etc. In this exemplary environment, the users have or otherwise use one or more application user devices 10, hereinafter referred to as “devices 10” to engage and interact with an application server 12 operated by an entity associated with the application. The application server 12 generally refers to any electronically available and communication-capable device or service operated by the entity associated with the application. For example, the application server 12 can be an online gaming server operated by an entity hosting an online multi-player game.

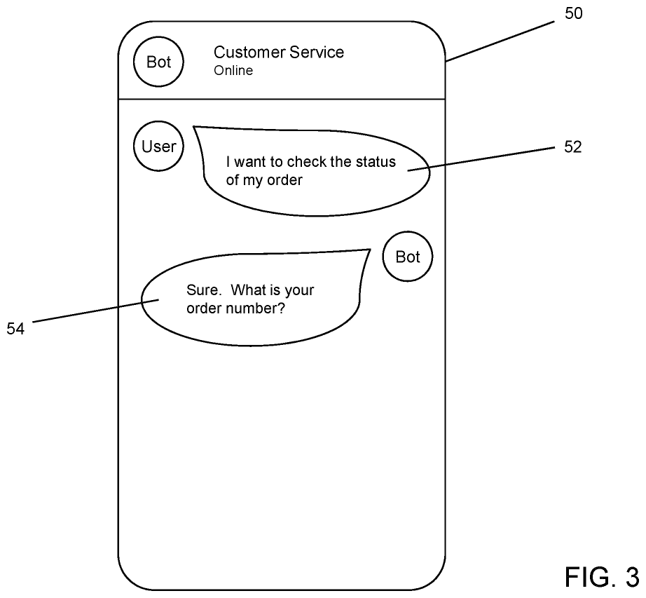

The application server 12 would typically host a website or other electronic user interface and in this example includes or provides access to a chat feature 14. The chat feature 14 can include an instant messaging style chat interface as shown in FIG. 3, and can be embedded as a widget or applet, or be provided in a separate but linkable application page, tab or other user interface element. As illustrated in FIG. 3, such a chat interface 50 can include user messages 52 and bot messages 54, arranged in a manner similar to a messaging interface between two human correspondents. The CS component of the application 12 can also optionally include a human agent 18, as shown in FIG. 1. As such, the chat feature 14 shown in FIG. 1 can integrate with both a chatbot 16 and a human CS agent 18. To address the aforementioned challenges, a chatbot creation, editing, and execution system 20, hereinafter the “system 20” can be provided, for creating and managing aspects of the chatbot 16.

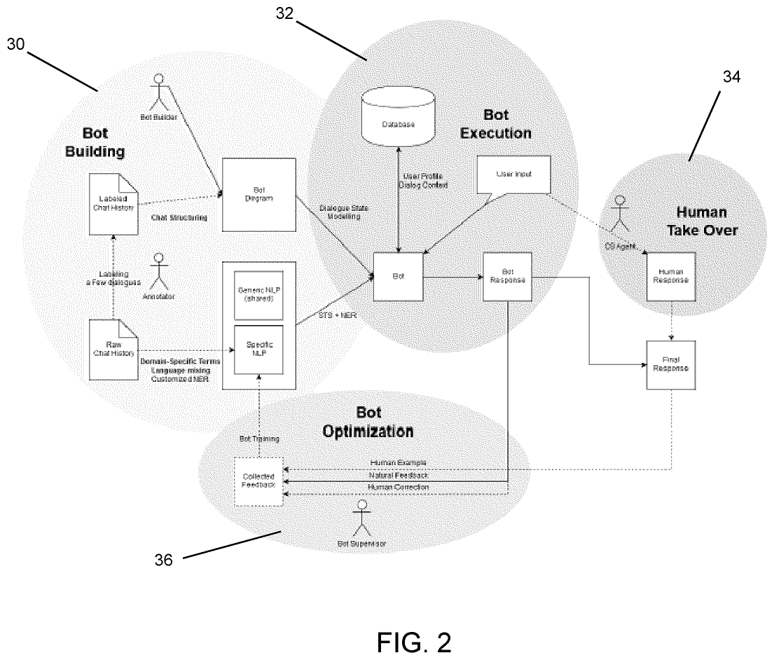

Turning now to FIG. 2, the system 20 can be used in various stages of the CS experience. In the example workflow shown in FIG. 2, the system 20 contributes to, controls, or otherwise influences or affects a bot building stage 30, a bot execution stage 32, a human take over stage 34, and a bot optimization stage 36. The bot building stage 30 uses raw chat history to determine domain-specific terms, language mixing, and customized named-entity recognition (NER) to develop specific NLP that is used with generic (shared) NLP by a bot during execution. The bot building stage 30 also includes an annotator using the raw chat history to label a few dialogues to generate a labeled chat history. The labeled chat history can then be used in chat structuring, as explained in greater detail below, to develop the conversational flow (i.e. script) that the bot follows, which flow can be displayed in a bot diagram. The bot diagram can then be used to apply dialogue state modeling for the bot execution.

The bot execution stage 32 involves implementing and executing the bot, which obtains user profile dialogue context (if available) and receives user inputs to generate bot responses. The bot responses can also be fed back into the bot optimization stage 36 as natural feedback. The natural feedback, along with human examples obtained from a final response, and human corrections determined from human intervention, forms a set of collected feedback that is used in ongoing bot training. The human take over stage 34 involves the optional take over by a CS agent during the chatbot conversation in order to generate a human response (where necessary), in order to generate the final response.

### Chat Structuring

A conversation turn means a consecutive utterance-response pair, an utterance from the user and a response from the agent. Generally, there are four different types of turn in a dialogue, in terms of their role:

### 1. Chit-Chat

Chit-chat refers to fillers between functional turns to make the conversation flow more smoothly, including greeting, non-senses, and even flirting. If the robot cannot reply to them, then the conversation may not be able to continue. For example, “How is the weather you there?”, “Do you like basket ball?”, “How old are you?”, “Are your a girl?”, are labeled as chit-chat or “CC” herein.

### 2. Single-Turn Task

A single-turn task refers to context-independent question and answers, like “How many branches do you have?”, “What's the refund policy?”, “What kinds of service do you offer?”. Those are labeled as single-turn of “ST” herein.

3. Multi-Turn Task that Spreads for Several Interactions

For a multi-turn task that spreads for several interactions, the utterance which triggers a follow-on conversation is labeled here as “MTB” accordingly. For example, “I forgot my password”, “I want to check the status of my order”, and “How can I setup a credit card as payment method?”. Following turns of a multi-turn task are labeled as “MTI” herein. These utterances are to provide further information inquired in the previous response. The final interaction is labeled as “MTE” herein.

### 4. Otherwise

Other turns, not categorized as above, are denoted by “0” herein.

It is postulated that, by definition, the response of a ST and MTB depends only on its utterance and a user profile (denoted as a trigger), while the response of CC, MTI, and MTE turns depend not only on its utterance but also the dialogue context. It has been observed on client data, that this assumption is supported. This also suggests that any sufficiently strong classifier should be able to predict a response based on an utterance of ST and MTB but would likely fail on CC, MTI, and MTE. Hence, instead of directly predicting whether or not a turn t=(u, r) is a trigger, the system 20 predicts how likely a response r comes after utterance u. This parallels with linear predictive coding (LPC) algorithms.

Let d be a dialogue {(ui, ri)|1≤i≤|D|}, where ui, ri are word sequences. For the i-th turn (ui, ri) we firstly use a bidirectional long short term memory (LSTM) encoder E to obtain sentence embedding:

$$e i u = E ( ui ) , \\ eir = E ( ri ) ,$$

where:

$$E ( s ) = [ \begin{matrix}{\vec{h}}_{n} \\ {\overleftarrow{h}}_{n}\end{matrix} ]$$

where \vec{h}ₙ, [symbol] are the output vectors at end positions from bidirectional LSTMs.

Then, eᵢ^{u} is applied to a feed-forward neural network g to measure the tendency of r being applicable to u, by its inner product with er:

f(ui,ri)=g(eᵢ^{u})^{T},eᵢ^{r}

g(x)=W²ReLU(W¹x+b¹)+b²

Following, the likelihood of r conditioning on u is given by:

$$P ( r i \vert u i ) = σ ( f ( ui , ri ) )$$

$$σ ( z ) = \frac{1}{1 + exp ( - z )}$$

where is the sigmoid function.

It may be noted that:

1. g maps eu to the same space because the same process is also used to predict the next utterance, and we see some sentences can be both utterances and responses.

2. This network structure is very similar to seq2seq except there is no decoder.

3. The structure can be viewed as a conditional sentence-level language model.

The training objective is to minimize the negative log-likelihood over the entire corpus:

$${C}_{L M} ( d ) = {\sum }_{i = 1}^{\vert d \vert} [ - ( ln P ( {r}_{i} \vert {u}_{i} ) + ln P ( {u}_{i + 1} \vert {r}_{i} ) ) + ( {\sum }_{j = 1}^{A} ln P ( {r}_{j}^{′} \vert {u}_{i} ) + ln P ( {u}_{j}^{′} \vert {r}_{i} ) ) ]$$

rj′ and uj′ (randomly selected from across all dialogues in possession) are treated as negative samples. A is the ratio of the amount of negative samples with respect to the positive ones.

Finally, dialog turns with P(u|r) larger than a certain threshold T are considered triggers, which can be listed in descending order and continue pipeline (clustering, human validation, encode into bot).

### Supervision

The self-supervised method described above may encounter difficulties dues to overfitting. That is, the network remembers everything, even with regularization, so P(r|u) can be significantly large for most turns. Several conversations were randomly sampled as a set DL and each turn was annotated as a type described above.

Let yi∈{1,2,3,4,5,6} be the label index or turn tᵢ, representing CC, ST, MTB, MTI, MTE, O, respectively. One can train a five-class classifier to predict the type of the given turn as follows:

$${q}^{i} = σ ( LSTM ( [ \begin{matrix}{e}_{i}^{u} \\ {e}_{i}^{r}\end{matrix} ] ) ) , q ϵ {R}^{6}$$

By minimizing the classification cross entropy and the difference between language model:

$${C}_{T C} ( d ) = {\sum }_{i = 1}^{\vert d \vert} - ln {q}_{{y}_{i}}^{i} + {α ( {q}_{S T}^{i} + {q}_{M T B}^{i} - P ( {r}_{i} \vert {u}_{i} ) )}^{2}$$

Hence, to jointly optimize both objectives, the model can be trained as:

$$C = {\sum }_{d ∈ {D}_{L}} {C}_{T C} ( d ) + μ {\sum }_{d ∈ D} {C}_{L M} ( d )$$

where μ is a hyper parameter.

### Example Case Study

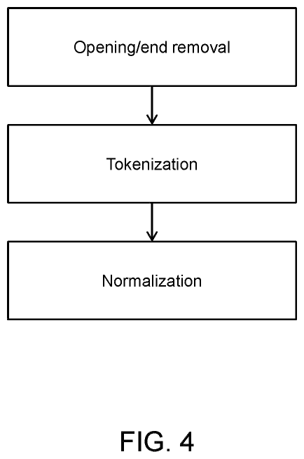

In this example case study, 23,409 conversation logs were collected from a CS unit of an essay/resume writing website. At the beginning of pipeline, chat history is processed as shown in FIG. 4 and summarized below:

### 1. Opening/End Removal

Greetings like “Hi, this is Tim at your service. How can I help you?” and acknowledgement messages such as “It's a pleasure to assist you. To help us improve our service, please rate the quality of this service” are removed.

### 2. Tokenization

Utterances and responses are tokenized into words and punctuation marks.

### 3. Normalization

Special and infrequent words and entities like names, dates, times, URLs, email addresses, order numbers, credit card numbers, and phone numbers are substituted with specific categorical tokens.

After preprocessing, some statistics shown below in Table 1.

TABLE 1

| | |
|---|---|
| # of conversations | 23,409 |
| # of turns | 216,286 |
| # of turns per conversation | 9.24 |
| vocabulary size | 34,019 |
| # of words | 3,374,831 |

In this example, the system 10 was used to annotate 462 conversations, which were sampled from 23,409 conversations. Table 1 illustrates that in this example there were 216,286 turns, and this averages 9.24 turns per conversation. The vocabulary size found was 34,019 and the number of words processed was 3,374,831.

Additional findings are shown in Table 2 below, and summarized thereafter.

```
TABLE 2
3922
1066 (21.1%)
  718 (18.31%)
  754 (19.22%)
1384 (35.28%)
```

In one sense, it was found that chit-chat only accounted for 21% of requests, which was found to be significantly lower than for e-commerce chatbots. It is assumed that this is because customers of essay-writing are more serious and desperate than of online shopping, leading them to not be in the mood to engage in casual chit-chat with agents.

In another sense, 35% non-chitchat utterances depended on context. This shows the importance and brings challenges to handle multi-turn conversations. For example, “I want to change the due day of it” where “it” refers to the order mentioned in previous chats.

In yet another sense, it was found that bots can automate at least 37.5% of total requests. For single-turn task (type 2), a bot can respond from knowledge base; for multi-turn task (type 3), a bot, in the most naive implementation, can identify the intent, collecting necessary information and then send to human agents to continue chats of type 4.

### Results

### Evaluation on Turn Type Classification

The quality of turn type classification on labeled data of a validation set was evaluated. It was seen that the precision on triggers is significantly lower than that on non-triggers. By error analysis, it was found that most errors are caused by the same order of collecting information in various tasks. Table 3 below shows how well the system can distinguish the two properties, namely “trigger” and “non-trigger”.

TABLE 3

| Type | Recall | Precision | F1 |
|---|---|---|---|
| Trigger | 0.7948 | 0.7091 | 0.7495 |
| Non-trigger | 0.9102 | 0.8807 | 0.8952 |

### Evaluation on Found Triggers

Next, human validation was performed on the top k triggers among all unlabeled data. Known intents are tasks that a client presumes to be common and lists to automate, such as check_status, place_order, complain, refund. Unknown intents need to be found in the chat history.

### CONCLUSION

It is first observed that although humans can provide most important intents, they cannot enumerate most possible expressions. The system 20 is able to find the utterances of same intents up to 6.4 times more (39.5%/6.1%). This is important to ensure quality and robustness of the chatbot 16.

It is also observed that one can find many repeated and fixed patterns of conversation of which humans are unaware. Even better, the unknown triggers found can be automated easily because most of them are just single-turn FAQs like “Do you have any new grad samples?” and “Do you offer a combination of LinkedIn?”. This marginally increases the capacity of bot by 31.8%! (39.5%+6.1%)=69.7%, and it only requires a manual check for a few hundred sentences (less than 1% of all data). Table 4 below shows that if one were to do the analysis by one's imagination and have a perfect NLP engine, one can at most know 39.5%/32% of his/her chats. But, if one does the analysis with the presently described system, one can handle the sum of first two rows (39.5+31.8).

TABLE 4

| | | |
|---|---|---|
| Different utterance of known intents | 39.5% | 32.0% |
| Utterance of unknown intents | 31.8% | 26.4% |
| Not a trigger | 22.6% | 37.5% |
| Exact same utterance of known intents | 6.1% | 4.1% |

In summary, the system 20 is configured to provide a general solution to extract automation-ready dialogues from chat histories, aiming to help enterprises fully utilize their data to build a high quality chatbot 16. The process requires little human effort to expand the capacity and increase the robustness of the chatbot 16. It can be appreciated that in bot building, the presently described algorithm can be used to find useful information in chat histories, and in bot optimization can be used to find new topics or questions.

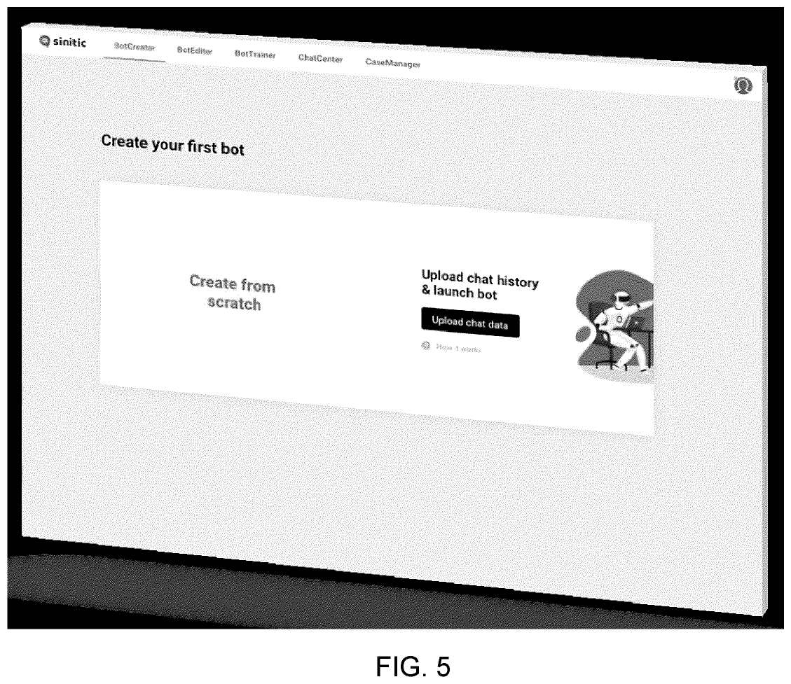

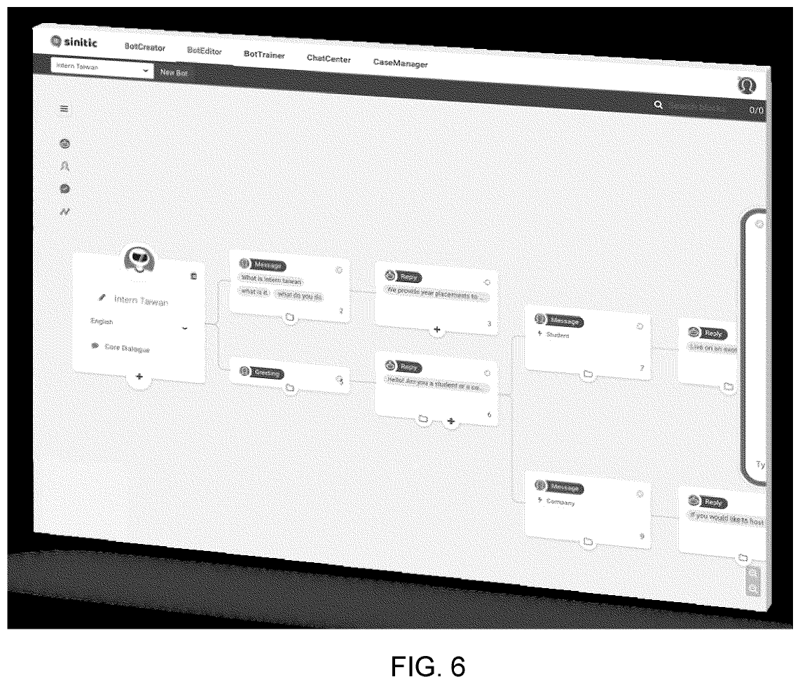

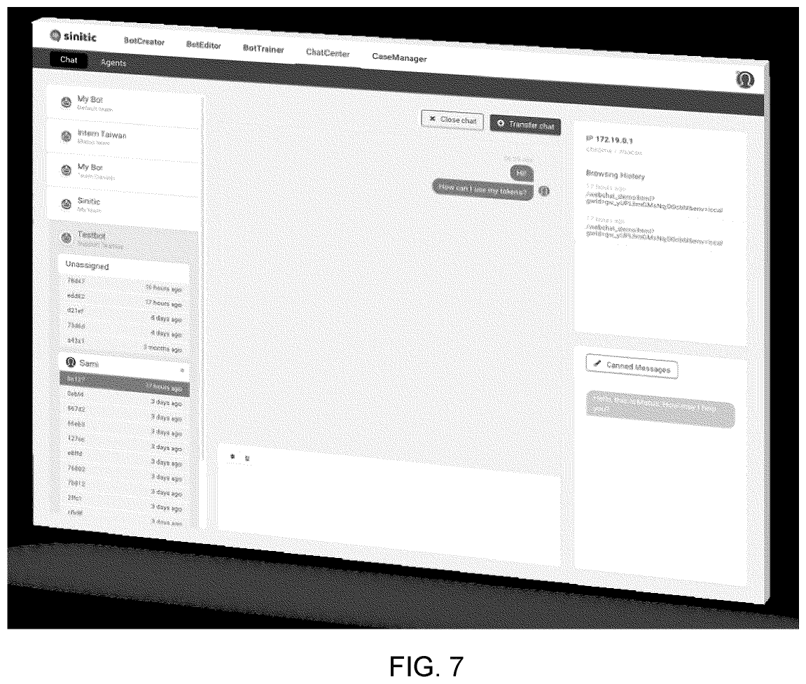

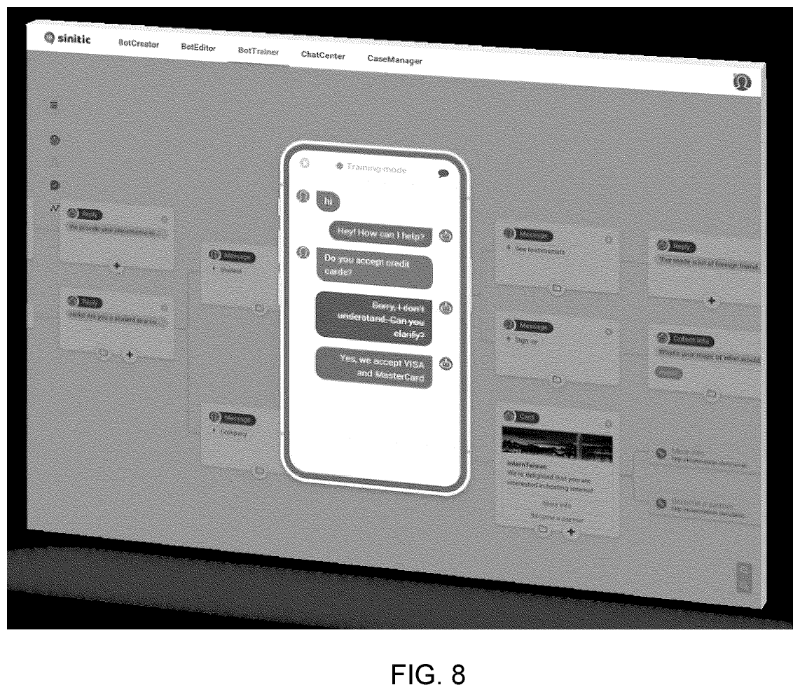

FIGS. 5 to 8 provide screen shots of exemplary user interfaces that can be used by or with the system 20. In FIG. 5 a bot creation user interface is shown in which a chatbot 16 can be built from scratch, or an existing chatbot 16 adapted by analyzing chat history. For example, years of chat history can be analyzed using the deep-learning algorithm described above to create a new and more efficient chatbot 16. In FIG. 6, a chatbot editor user interface is shown, which can be used to train and design a chatbot 16 with API integrations and advanced logic for multi-turn and multi-task conversations. In FIG. 7, a user interface for integrating a chat bot with a human agent interface is shown. This allows human agents to be augmented with chatbots 16 to increase productivity and decrease operating costs. In FIG. 8, a bot trainer user interface is shown, which can be used to approve chatbot dialogue improvements, or observe automated updates that pass the confidence threshold, used during bot optimization.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 20, any component of or related to the system 20, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of chat structuring comprising:
obtaining data associated with one or more chats;
labeling a set of seed conversations from the data; and
executing a chat structuring process.

2. The method of claim 1, further comprising developing specific natural language processing from the data during a bot execution process.

3. The method of claim 1, further comprising providing the data to an annotator to receive labels for a plurality of chat dialogues.

4. The method of claim 1, wherein an output of the chat structuring is used to develop a conversation script for a chat bot to follow.

5. The method of claim 4, wherein the conversation script is displayed in a bot diagram, used to apply dialogue state modeling for bot execution.

6. The method of claim 2, further comprising receiving bot responses and feeding the bot responses to an optimization process to provide natural feedback for refining the natural language processing for subsequent bot executions.

7. The method of claim 1, further comprising providing an option to have a bot execution process taken over by a customer service agent for generating a final response.

8. The method of claim 1, wherein the chat structuring process comprises predicting how likely a response comes from an utterance.

9. The method of claim 8, wherein for each turn in a dialogue, a bidirectional long short term memory encoder is applied to obtain sentence embedding.

10. The method of claim 9, further comprising determining a likelihood of a response conditioning on an utterance.

11. The method of claim 10, wherein a training objective is used to minimize a negative log-likelihood over an entire corpus.

12. The method of claim 11, wherein dialogue turns with the likelihood of response conditioning on the utterance being larger than a threshold are considered triggers.

13. The method of claim 12, further comprising randomly sampling a plurality of conversations; and applying a supervision process to annotate the sampled conversations.

14. A computer readable medium comprising computer executable instructions for performing the method of claim 13.

15. A system for chat structuring comprising a processor and memory, the memory storing instructions for performing the method of claim 13.
